(19) United States
(12) Patent Application Publication
(10) Pub. No.: US 2026/0278443 A1
(43) Pub. Date: Sep. 17, 2026

(54) Method for Exploiting Dissipation in Computing Systems to Improve Algorithmic Performance

(71) Applicant: Universities Space Research Association, Columbia, MD (US)

(72) Inventors: Davide Venturelli, Miami, FL (US); Filip Bartosz Maciejewski, Mountain View, CA (US); Jacob Biamonte, Milton-Freewater, OR (US); Stuart Hadfield, Brooklyn, NY (US)

(21) Appl. No.: 19/016,502

(22) Filed: Jan. 10, 2025

Related U.S. Application Data
(60) Provisional application No. 63/619,730, filed on Jan. 10, 2024.

(51) Int. Cl. G06N 10/60; G06N 10/20; G06N 10/40

(52) U.S. Cl. CPC G06N 10/60; G06N 10/20; G06N 10/40

(57) ABSTRACT

We present Noise Directed Adaptive Remapping (NDAR), a heuristic method to approximately solve optimization problems using a system featuring the presence of biased noise. We assume that the system dynamics has a global attractor state—a canonical example of system with noise fulfilling this assumption is a quantum processor subject to the amplitude damping channel, a type of noise prevalent in superconducting quantum devices. NDAR bootstraps the attractor by iteratively gauge-transforming cost-function Hamiltonian and proceeding in a greedy fashion or via a more sophisticated search. In each iteration step, the gauge transformation effectively changes the attractor state into a lower energy state of the cost Hamiltonian based on the results of runs in the previous step. Intuitively, thanks to the gauge transformations, noise aids state preparation for the variational optimization, as opposed to hindering it. We demonstrate the effectiveness of our protocol in experiments with subsystems of Rigetti's superconducting quantum device. Using the basic version of the method, we obtain approximation ratios (of best-found outcomes) above ≈0.9 for multiple instances of random, fully connected graphs on n=82 qubits, using only p=1 (noisy) QAOA in conjunction with QDR, compared to ≈0.3 for standard QAOA with the same amount of function calls. More advanced version of the methods have been tested, further improving the quality to solution to optimality and decrease the runtime by at least 3 times the basic version.

### STATEMENT OF GOVERNMENT INTEREST

The invention was made with support from the NASA Academic Mission Services (NAMS) contract number NNA16BD14C; and National Science Foundation (NSF) Contract number 1918549. The government may have certain rights in the invention.

### SUMMARY OF THE INVENTION

The system is a device with processing elements acting on qubits which is subject to a source of noise for which the steady state (in absence of other interactions) is a known state (labeled the “0-state”). According to various features and embodiments of the invention:
Processing elements could be gates or programmable interactions,
Qudits may be used instead of qubits,
P-Bits may be used instead of bits,
Noise may be engineered via an artificial bath (e.g. extra variables, stochastic perturbations),
Noise may be engineered algorithmically (e.g. Markov-Chain Monte Carlo),
Physical representations of classical vector spins may be used instead of discrete variables,
The invention may be used,
   a. if the 0-state is not known but the fact that it exists is known,
   b. if the 0-state is not unique (i.e., there exist multiple steady states),
   c. if instead of a steady state, it is a metastable state or another attractor state.

Examples of devices that may be used or which may benefit according to the invention include:
neutral atom gate-model or analog processors,
ion gate-model or analog processors,
photonic gate-model or analog processors,
superconducting gate-model or analog processors (including quantum annealers),
silicon impurity gate-model or analog processors,
electron-on-helium gate-model or analog processors,
optical Coherent Ising Machines and variants,
a network of non-linear processing elements such as memristors, self-organizing gates, classical spins in magnetic devices, or neuron implementations.

Devices according to the invention may be used in combination with an optimization problem to be solved specified by objective function, variables and coefficients, and an algorithm that, depending on parameters, outputs a bitstring (as a result of measurement) which is sampled from a probability distribution. The quality of an output is evaluated via the value of the objective function. According to various additional features and/or embodiments of the invention:
Strings of integers/symbols may be use instead of bitstrings,
Measurement may be quantum collapse, weak quantum measurement or just standard readout in non-quantum memory,
The objective function may be a quantum Hamiltonian or other operator and the output may result from measurements following an information processing protocol (e.g. shadow tomography),
The device may output a set of multiple outputs instead of one,
The objective function need not be explicitly known; it may, for example, be accessible remotely or encoded in a neural network, as long as the transformation is implementable.

Examples of algorithms that may be employed according to the invention include:
Adiabatic quantum computing or its dissipative variants,
Quantum annealing,
The Quantum Approximate Optimization Algorithm (QAOA) or the variational quantum eigensolver (VQE) or other variational ansatz such as Recursive QAOA (RQAOA), Iterative Quantum Optimizers (IQO), Quantum Alternate Mixer-Phaser Ansatz (QAMPA), ADAPT-QAOA, Digitized Counterdiabatic Quantum Optimization (DCQO) and variants, Quantum Relax and Round (QRR), and other variants,
Simulated Bifurcation Machines and variants,
Simulated annealing and parallel tempering algorithms and embodiments in digital or analog architectures, and variants.

The objective function may be transformed by multiplying its coefficients by real numbers, by a re-definition of the basis of measurement (classical or quantum), or by applying a quantum channel (e.g., a unitary) to the operators specifying the cost function A set of transformations is associated to a family of ‘equivalent’ problems that is generated by the application of these transformations and each transformation is associated to a state via the re-definition of the basis from the original 0-state (which becomes the transformed-0-state). According to various embodiments of the invention:
Transformation may correspond to a gauge symmetry of the objective function that leaves the objective function invariant or approximately invariant,
A subspace of high-quality solutions may be preserved or re-mapped to a similar-size subspace (for example a transformation inspired by Schrieffer-Wolff or adiabatic renormalization principles).

Examples of symmetry according to various embodiments or features of the invention include:
The Z2 group or spin-reversal transform symmetry,
SU(n) or SO(n) symmetries for qudits and vectors, including variable permutation,
Other approximate or hidden symmetries.

The method starts in post-processing of the outputs of a series of runs of the device for the purpose of identifying a target transformation to be applied for the next iteration of runs. The highest-quality output is recorded for this run campaign. According to various features and embodiments of the invention, the following steps and/or options may be carried out:
Selecting the transformation whose transformed-0-state corresponds to the highest quality output of the run,
Selecting the transformation whose transformed-0-state is associated with a specific Hamming distance of the bitstring or other distance with respect to the 0-state,
Selecting the transformation whose transformed-0-state is associated with a specific distance with respect to a state other than the 0-state which is a reference state computed via a physical model or via empirical considerations, for example from an alternative classical algorithm,
Selecting a transformation via a neural-network or an algorithm taking as input the output of an iteration or of multiple iterations which has been designed or trained to discover the best transformation based on prior data and physics-informed design principles,
Selecting multiple transformations instead of a single one, using the methods above,
Post-processing may include error-mitigation, suppression or correction techniques to generate new derivative output that is used in the algorithm,
The output may be measurement results (including weak quantum measurement) of a subset of the variables during method execution (e.g. mid-circuit measurement) at different times instead of measuring at the end to collect the output. Measurement results could also be used to modify the method adaptively.

Example of a series of runs include multiple runs of the same setting, and adaptively using a parameter-setting strategy until a stopping condition.

The second step and subsequent steps of the method are to use the identified transformation to re-program the device and run the transformed problem to generate new outputs. From these outputs a new transformation can be chosen, and the procedure can be repeated until a final iteration of the method after which the highest quality output of all the samples generated since the beginning is used as a final solution. According to various embodiments and options:
The optimization algorithm or its parameter setting strategy may be changed at each iteration,
Branching the method in a decision tree consisting of multiple parallel (or sequentially scheduled) runs for which multiple choices of transformations may be made at each iteration,
Multiple final solutions may be chosen instead of a single one,
Different metric rather than quality may be used to select the final solution,
Iterations may include adding gate-operations to the same quantum circuit without a full projective measurement (for which case the transformation would be implemented online via, for example, a measurement-feedback mechanism on a subset or the totality of qubits).

### BRIEF DESCRIPTION OF DRAWINGS

FIG. 1 shows a correlation between numerical simulated performance (Y-axis) of p=1 QAOA for n=16 qubits and the approximation ratio (X-axis) of the Z2 gauge transformation applied to the optimized Hamiltonian. The colormaps (2-dimensional histogram) show the distributions of aggregated data points for 10 random Sherrington Kirkparrick (SK) objective functions, each implemented with 20 random transformations. The left plot corresponds to perfect simulation, while the right plot to the amplitude damping noise affecting every gate. Each optimization was run using a Tree-structured Parzen Estimator (TPE) parameter optimizer with t=100 trials, and each trial entailed gathering s=256 samples (shots).

FIG. 2 shows a correlation between experimental performance (Y-axis) for n=82 qubits on the Rigetti Ankaa-2 chip running a single level of QAOA (p=1) and the approximation ratio (X-axis) of the Z2 gauge transformation applied to the optimized Hamiltonian cost function. The colormap (2-dimensional histogram) shows the distribution of aggregated data points for 10 random SK objective functions, each implemented with 20 random Z2 gauges. Each optimization was run using TPE with t=100 trials, and each trial entailed gathering s=1000 samples (shots).

FIG. 3 shows the performance of the method (named noise-directed adaptive remapping or NDAR) algorithm in n=82-qubit variational optimization using p=1 QAOA. The X axis shows the iteration number (see Algorithm 1). The Y axis shows the approximation ratio (energy estimated divided by the ground state energy). Each dashed line corresponds to a different random Hamiltonian instance, solid lines indicate the maximal and minimal performance across 10 instances. For a fixed iteration i, the data points correspond to the best sample out of the 1000*150*(i+1) (with i being the iteration number), hence they correspond to the best-found solution. The orange points correspond to the NDAR implementation of QAOA. The blue and grey points constitute a baseline that corresponds to the best sample obtained via standard QAOA without NDAR (blue) and uniformly random sampling with the same number of samples as experiments (grey). In the case of QAOA (with and without NDAR), the results are obtained via TPE optimizer with 150 trials (involving gathering 1000 samples each) for each iteration step.

FIG. 4 shows a version of NDAR “extended NDAR” with an advanced protocol. The improved protocol includes pre-processing the initial transformation out of 10,000 randomly generated, the use of four transformations instead of one to seed the next iteration of NDAR, a post-processing step using a variant of quantum Relax and Round algorithm (w-QRR), and a local search of the Hamming neighborhood of the best sample (HDQLS). Here, the end of each colored region corresponds to AR, resulting from the application of the corresponding algorithm step (“cl” stands for classical processing). For example, the improvement gained directly from the quantum run (in this case the Time-Block “TB” QAOA, which is an improved version of QAOA) is indicated by the change in the AR value indicated by the pink line. Different lines are different Hamiltonian objective function instances.

### DETAILED DESCRIPTION OF THE INVENTION

### 1 Preliminaries

### 1.1 Gauge Transformations (Bitflip Transforms)

Representation of any Hamiltonian has an implicit degree of freedom that comes from the choice of basis. Any classical (i.e., diagonal in the computational basis) Hamiltonian can be represented as

$$H = {\sum }_{x} {λ}_{x} \vert x 〉 〈 x \vert , \qquad ( 1 )$$

where we label the standard n-qubit computational basis by bitstrings

$$\vert x 〉 := {⊗}_{i = 0}^{n - 1} \vert {x}_{i} 〉 ,$$

with xᵢ∈{0, 1}, and λₓ denotes corresponding eigenvalue.

Let us denote by Py a bitflip operation that applies Pauli matrix Xi on qubit i if yᵢ=1 and identity otherwise, i.e.,

$${P}_{y} = {⊗}_{i = 0} {X}_{i}^{m} and {P}_{y} \vert x 〉 = \vert y {⊕}_{2} x 〉$$

with ⊕₂ denoting bitwise addition modulo 2. Any classical Hamiltonian can be transformed via P_{y} as

$$\begin{matrix}H \to {H}^{y} = {P}_{y} {HP}_{y} \\ = {\sum }_{x} {λ}_{x} {P}_{y} \vert x 〉 〈 x \vert {P}_{y} \\ = {\sum }_{x} {λ}_{x} \vert {P}_{y} x 〉 〈 {P}_{y} x \vert \\ = {\sum }_{x} {λ}_{{P}_{y} x} \vert x 〉 〈 x \vert .\end{matrix} \qquad ( 2 )$$

The last equality means that one can either interpret this transformation as assigning eigen-value λₓ to the transformed vector P_{y}|x [symbol] , or as assigning eigenvalue λ_{Pyx} to original vector |x [symbol] .

Without loss of generality, let us now consider a fully-connected 2-local Hamiltonian of the form

$$H = {\sum }_{i < j} {J}_{i , j} {Z}_{i} {Z}_{j} , \qquad ( 3 )$$

where Zᵢ is Pauli Z operator acting on qubit i, and J_{i,j}∈R is interaction strength between qubits i and j. For such a local Hamiltonian, the above-mentioned duality can be seen in the following way. The bitflip P_{y} can be applied to every local term, either by directly transforming Zᵢ to −Zᵢ if yᵢ=1, or by incorporating the change of signs to the weights J_{i,j}, hence

$${J}_{i , j} {Z}_{i} {Z}_{j} \to {{J}_{i , j} ( - 1 )}^{{y}_{i}} {{Z}_{i} ( - 1 )}^{{y}_{i}} {Z}_{j} = {J}_{i , j}^{y} {Z}_{i} {Z}_{j} , \qquad ( 4 )$$

$$where {J}_{i , j}^{y} = {( - 1 )}^{{y}_{i} + {y}_{j}} {J}_{i , j} , and$$

$$H \to {H}^{y} = {\sum }_{i < j} {J}_{i , j}^{y} {Z}_{i} {Z}_{j} = {\sum }_{i < j} {( - 1 )}^{{y}_{i} + {y}_{j}} {J}_{i , j} {Z}_{i} {Z}_{j} . \qquad ( 5 )$$

### 1.2 Gauge-Transformed QAOA Circuits

We now consider n-qubit QAOA circuit of depth p given by

$$U ( H ; γ ; β ) = {\prod }_{i = 1}^{P} {U}_{M} ( {β}_{t} ) {U}_{PS} ( H ; {γ}_{l} ) , \qquad ( 6 )$$

with phase separator

$${U}_{PS} ( H ; {γ}_{l} ) = exp ( - i {γ}_{l} H ) , and mixer \qquad ( 7 )$$

$${U}_{M} ( {β}_{k} ) = {⊗}_{j = 0}^{n - 1} exp ( - i {β}_{k} {X}_{j} ) . \qquad ( 8 )$$

As initial state, we use standard |+1 [symbol] ^{⊕n}, where

$$\vert + 〉 = \frac{1}{\sqrt{2}} ( \vert 0 〉 + \vert 1 〉 ) .$$

Consider the probability of obtaining bitstring x after implementing QAOA circuit to the initial state

$${〈 x \vert U ( H ; γ ; β ) \vert + 〉}^{⊗ {}_{n}} . \qquad ( 9 )$$

We now apply bitflip P_{y} to the Hamiltonian H→P_{y}HP_{y}, and consider the probability of obtaining re-labeled basis element P_{y}|x [symbol] =|P_{y}x [symbol] , i.e.,

$${〈 {P}_{y} x \vert U ( {H}^{y} ; γ ; β ) \vert + 〉}^{⊗ {}_{n}} . \qquad ( 10 )$$

Note that this exactly corresponds to running standard QAOA for a gauge-transformed Hamiltonian H^{y} (relabeling the basis elements as |P_{y}x [symbol] corresponds to changing the measurement basis to account for gauge-transformation of H^{y}). First, we notice that since H is diagonal, we have

$${U}_{PS} ( {H}^{y} ; \text{?} ) = exp ( - i \text{?} {P}_{y} {HP}_{y} ) = {P}_{y} exp ( - i \text{?} H ) {P}_{y} . \qquad ( 11 )$$

$$\text{?} \text{indicates text missing or illegible when filed}$$

In Eq. (6), we thus have multiple inner terms of the form

$${P}_{y} {U}_{M} ( {β}_{l} ) {P}_{y} {U}_{PS} ( H ; \text{?} ) = {U}_{M} ( {β}_{l} ) {U}_{PS} ( H ; \text{?} ) , \qquad ( 12 )$$

$$\text{?} \text{indicates text missing or illegible when filed}$$

which follows from the fact that P_{y} commutes with mixer U_{M} (β_{I}), and

$${P}_{y}^{2}$$

square is =1. Inner terms do not contribute, leaving two outer terms P_{y}|+ [symbol] ^{⊕n}=|+ [symbol] ^{⊕n} is left invariant because |+ [symbol] is the eigenstate of X with eigenvalue 1. The last term is [symbol] P_{y}x|P_{y}= [symbol] P_{y}P_{y}x|= [symbol] x|, we obtain that

$${〈 {P}_{y} x \vert U ( {H}^{y} ; γ ; β ) \vert + 〉}^{⊗ {}_{n}} = {〈 x \vert U ( H ; γ ; β ) \vert + 〉}^{⊗ {}_{n}} . \qquad ( 13 )$$

We see that the outcome probabilities of the QAOA circuit (and thus any expected values) are invariant under the above-described transformation.

It is important to clearly state what is the operational interpretation of the above operation. In practice, it corresponds to implementing a QAOA circuit for gauge-transformed Hamiltonian H^{y}, followed by gauge-transforming the measurement basis using P_{y}; in other words, implementing standard QAOA with a new cost function H^{y}. Typically it corresponds to physically implementing a new phase separator

$$( - {iH}^{y} {γ}_{t} ) ,$$

and changing the measurement basis to [symbol] P_{y}x| in post-processing (in practice, this is done by either evaluating energies of measured bitstrings {|x [symbol] } on gauge-transformed Hamiltonian H^{y} or by evaluating energies of original Hamiltonian H on transformed bitstrings {P_{y}|x [symbol] }). Note that this is mathematically equivalent to applying basis transformation defined by P_{y} to every unitary in the circuit, but is operationally different from it—change of basis would correspond to applying P_{y} to every unitary, as opposed to just phase separators. We make the above distinction because that equivalence (between running QAOA for H^{y} and change of basis) does not hold if the circuit is noisy or if the mixer does not commute with P_{y} (or the initial state is not left invariant under the action of P_{y},)—as is the case for different ansatze such as Quantum Alternating Mixer-Phaser Ansatz [1]. See [2] for more discussion on the symmetries of QAOA circuits.

In the above discussion, we saw that the outcome probabilities of the QAOA circuit have a symmetry defined by bitflip transformation of H that ideally leaves all probabilities invariant (which justifies using the name “gauge transformation”). However, this symmetry is broken by the presence of noise. This is most easily seen using Kraus representation of a noise channel. Consider Kraus operator Km applied to the circuit part UPS

$${U}_{PS} ( {H}^{y} ; {γ}_{t} )$$

$${K}_{m} {U}_{PS} ( {H}^{y} ; \text{?} ) = {K}_{m} {P}_{y} {U}_{PS} ( H ; \text{?} ) {P}_{y} , \qquad ( 14 )$$

$$\text{?} \text{indicates text missing or illegible when filed}$$

which demonstrates that P_{y} cannot be commuted out like before unless [P_{y}, Kₘ]=0 for every Kₘ that defines the channel. The same holds for the noise applied to mixers if one would implement change-of-base unitaries P_{y}.

In the continuous-time description, we have a state evolving according to Lindbladian [symbol] + [symbol] , and the bitflip gauge transformation gives

$${tr ( \vert {P}_{y} x 〉 〈 {P}_{y} x \vert exp ( {ℋ}^{y} + 𝒟 ) ( \vert + 〉 〈 + \vert}^{n} ) ) . \qquad ( 15 )$$

where, again, the dissipative part [symbol] cannot be, in general, easily decoupled from internal system evolution governed by [symbol] . Note that in the noiseless case, the above equation can be reduced to Eq. (13)—for example, by defining Hamiltonian that is a linear combination of square waves which apply the mixer and cost Hamiltonian consecutively after time consistent with QAOA angles.

Importantly, when implementing QAOA Hamiltonians in experiments, we can run a phase separator corresponding to the gauge-transformed Hamiltonian, but it is not possible to control the dissipative part. However, by changing the measurement basis in post-processing we can effectively change the stationary state of the dynamics, which we exploit in the following sections to improve QAOA optimization.

### 2 Adaptive Remapping

From the discussion in the previous section, it follows that unless noise Kraus operators commute with bitflips, the Eq. (13) ceases to hold, and different bitflips will, in general, result in different QAOA's performance. This fact could potentially be exploited to improve optimization.

In the case of amplitude damping, the Kraus operators do not commute with the bitflips, which suggests that gauge transformations will affect the QAOA's performance. Note that standard amplitude damping channel has attractor state |0 . . . 0 [symbol] 0 . . . 0| that, under bitflip transformation, is transformed to P_{y}|0 . . . 0 [symbol] 0 . . . 0|P_{y}=|y [symbol] y|. Applying bitflip gauge transformation to the Hamiltonian thus gives the power to effectively choose the attractor state of the noise (this is done on the level of post-processing). A trivial example of exploiting this fact is to choose a bitstring y^{GS} that is the ground state of the cost Hamiltonian. If that is the case, the stationary state of the amplitude damping channel becomes the ground state of the Hamiltonian, and thus the device's dynamics eventually converges to the ground state even without any optimization. Clearly, this example is not useful since it requires knowing the solution to the problem beforehand.

Inspired by the above observations, we propose the Noise-Directed-Adaptive-Remapping (NDAR) method (summarized in Method 1). The NDAR consists of multiple iterations, where each iteration involves implementing a variational optimization for a gauge-transformed Hamiltonian. The gauge transformation in each step is chosen based on the results of the optimization in the previous iteration—it is defined by the lowest-energy bitstring obtained so far. The NDAR ensures that the steady state of the noise in each recursion step is the lowest energy state observed so far. This recursively changes the optimized cost function in a way that greedily improves the energy of the attractor state, potentially leading to improved optimization. In Algorithm 1 we leave generic TERMINATION RULE to describe a stopping condition for the algorithm. Various heuristics can be used—for example, terminate if the best-found energy did not decrease relative to the previous iteration step; or terminate if the optimized cost function (such as the mean value of the energy) did not decrease; or terminate if neither of the above happened. In later sections, we implement NDAR in experiments on n=82 qubits and observe great performance improvements for fully connected 2-local Hamiltonians.

Method 1: Noise Directed Adaptive Remapping

### Input:

H₍₀₎: classical Hamiltonian encoding the cost function to be approximately minimized variational optimizer: a sub-algorithm that performs hybrid quantum-classical variational optimization aiming to solve H₍ⱼ₎ (gauge-transformed Hamiltonian in iteration step j). Example: standard QAOA ansatz with any classical optimizer.
M: total number of samples in each optimization step
TERMINATION RULE: a rule specifying termination of the loop. Example: the energy did not decrease relative to the previous iteration.)
Pseudocode for recursion step j≥1:
   1. Run variational optimization for Hamiltonian H₍ⱼ₋₁₎ using variational optimizer. The result is M bitstrings (measurement outcomes)

$${\{ {x}_{i} \}}_{i = 1}^{M} .$$

2. Calculate energies

$${\{ {E}_{( j )} ( {x}_{i} ) = 〈 {x}_{i} \vert {H}_{( j - 1} ) \vert {x}_{i} 〉 \}}_{i = 1}^{M}$$

of the classical states

$${\{ {x}_{i} \}}_{i = 1}^{M}$$

on the Hamiltonian H₍ⱼ₋₁₎.
   3. Choose bitstring x* corresponding to the lowest energy E₍ⱼ₎(x*)=minᵢE(j)(xᵢ).
      if TERMINATION RULE:
      terminate
      else:
      proceed to step 4.
   4. Apply bitflip gauge specified by x* to the Hamiltonian H^{(j-1)}, obtaining new Hamiltonian

$${H}_{( j )} := {H}_{( j - 1 )}^{{x}^{*}}$$

(recall Eqs. (2) and (5)). This ensures that the transformed Hamiltonian H₍ⱼ₎ has the property

$$〈 00 … 0 \vert {H}^{( j )} \vert 00 … 0 〉 = {E}_{{x}^{*}}^{( j )} .$$

Note that H₍ⱼ₎ is equivalent to the original cost Hamiltonian H₍₀₎ via a series of gauge transformations defined by previous recursion steps, thus the solution to the original problem can be recovered easily. Set j=j+1. Proceed to step 1.

Remark 1: In the previous section (and in experiments presented later) we focus on analyzing and implementing the standard QAOA ansatz. However, we note that the NDAR can be applied for any ansatz circuit since it entails iteratively gauge-transforming the cost function that is done in post-processing. To account for that, we leave a generic variational optimizer as an input to NDAR. We note that variational optimizer can take as an input iteration step and gauge-transformed Hamiltonian, and thus we allow for updating the parameter setting strategy in consecutive iterations. In the case of QAOA experiments, we also modify the physically implemented phase-separator to account for gauge transformations.

Remark 2: In the discussion above we assumed that the attractor state of the noise is |0 . . . 0 [symbol] 0 . . . 0|. We note that QDR can also be applied to any classical attractor state of the form |x [symbol] x| via an analogous procedure.

Remark 3: Note that the analogous protocol could be applied if the single-attractor model does not hold exactly, but the device in question favors multiple fixed states.

### 3 Numerical Study

### 3.1 Bitflip Gauge Energy Vs QAOA Performance

We now numerically investigate how the choice of the bitflip gauge affects the results of variational optimization in the presence of amplitude-damping noise (e.g. T1 decay). As discussed previously, this type of noise has a global steady state |0, . . . 0 [symbol] . We thus conjecture that the optimization will perform better for bitflip gauges that transform a Hamiltonian in such a way that the approximation ratio (AR) of the attractor state

$$\frac{〈 0 … 0 \vert {H}^{y} \vert 0 , … 0 〉}{{E}_{GS}} = \frac{〈 y \vert H \vert y 〉}{{E}_{GS}} \qquad ( 16 )$$

is higher (E_{GS} denotes ground state energy). If that can happen, it will support the reasoning behind the use of QDR.

To test that hypothesis, we investigate a correlation between the approximation ratio (Eq. (16)) and the performance of the QAOA optimization as quantified by the approximation ratio of the cost Hamiltonian estimated on the optimized variational state (the estimator is constructed in the standard way by averaging multiple measurements of the Hamiltonian H^{Y}).

In our simulations, we use non-identical, uncorrelated amplitude-damping noise. A tensor-product, local two-qubit channel is applied to the circuit after every application of a two-qubit gate. The single-qubit gates are assumed to be noiseless. The parameters of the channels are inspired by calibration data from Rigetti's superconducting Aspen-M-3 QPU (this includes T1 times of individual qubits and the typical duration of 2-qubit gates). In our simulations, we assume linear connectivity of a device and implement an efficient SWAP network from [3](same as in [4]). This significantly increases circuit depth, making the simulations closer to what happens in experiments.

The Hamiltonian cost function we optimize corresponds to fully connected graphs

$$H = {\sum }_{i < j} {J}_{i , j} {Z}_{i} {Z}_{j} , \qquad ( 17 )$$

with 2-body interaction coefficients J_{i,j} drawn uniformly at random from ±1, (so-called Sherrington-Kirkpatrick model [5]).

We implement p=1 QAOA optimization for n=18 qubits with Tree of Parzen Estimators (TPE) [6, 7] optimizer using t=100 trials (cost function evaluations). Each trial corresponds to estimating the cost function value from s=1000 samples for a given set of angles (variational parameters). The QAOA is implemented for a set of 10 Hamiltonians. For each Hamiltonian, the optimization is run independently for 20 random bitflip gauges, i.e., at a given optimization, the original Hamiltonian is gauge-transformed via a random bitflip P_{y} and such optimizations are repeated for 20 random ys. Importantly, the optimizer seed is fixed in all simulations, meaning that the only sources of performance difference are statistical noise, the gauge transformation, and the varying hardness of optimization of particular Hamiltonian instances. For each optimization run, we estimate the approximation ratio of the final variational state and compare the result with the corresponding approximation ratio from Eq. (16). The simulations are performed using Qsim framework [8] that implements the quantum trajectories method [9] to approximate sampling from noisy circuits defined by Kraus operator sum representation.

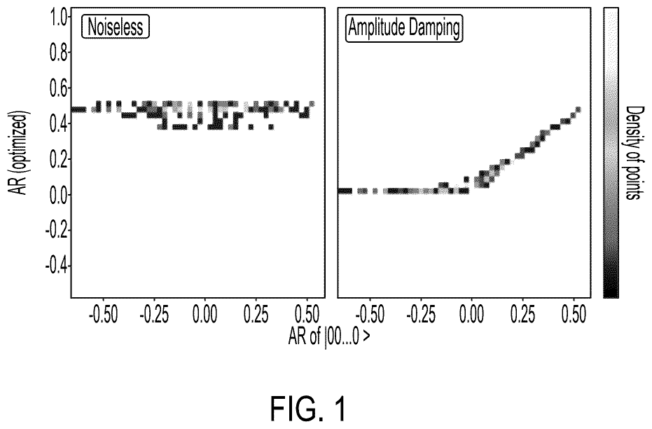

We aggregate the data for all test Hamiltonians and plot the results as density of points heatmap (2-dimensional histogram) in FIG. 1. In the presence of amplitude-damping noise (right plot), we observe a clear positive correlation between the approximation ratio of the noise attractor state |0 . . . 0 [symbol] 0 . . . 0| and the numerical performance of the QAOA optimization. In the noiseless case (left plot), as expected, we do not observe such a correlation, and the resulting histogram is a flat line (up to statistical fluctuations and variation in per-instance hardness of the Hamiltonians). This suggests that choosing a bitflip gauge defined by a low-energy bitstring can significantly aid the QAOA optimization.

### 3.2 Simulation Limitations

In the case of QAOA, the goal is to find a high-quality solution to a binary optimization problem encoded by the cost Hamiltonian. To properly assess the performance, one should thus look at the estimators of approximation ratio constructed from tails of the obtained distribution, as opposed to taking only the standard mean estimator that is used to guide the optimization (see, e.g., analysis in [4]). Indeed, the actual figure of merit that matters in practice is the best-obtained solution. In the case of our simulations, the actual ground state is found in almost all cases, independent of the noise and the gauge transform chosen. As we do not expect a ground state to be found for high-dimensional systems, we attribute this to the small system size (n=18) used in our simulations due to computational limitations. Due to that factor, there was no point in numerically implementing NDAR, as it would converge in step 0 in each studied case. In the next section, we study NDAR for n≥82 systems in experiments on Rigetti's quantum devices, and we observe high-performance improvements compared to standard QAOA.

### 4 Experimental Demonstration

In this section, we present the results of experiments performed on 82-qubit subsystems of Rigetti's superconducting transmon device Ankaa-2.

### 4.1 Bitflip Gauge Energy Vs QAOA Performance

We start by performing an investigation of the correlation between the performance of variational optimization and the energy of the |0 . . . 0 [symbol] 0 . . . 0|state on the gauge-transformed Hamiltonian; similarly to numerics presented in Section 3.1. Here we study the cost function of the Hamiltonian of the form from Eq. (17) with 2-body interaction terms chosen randomly as −1 or 1, same as in numerical experiments. To implement the fully connected circuits, we use the efficient SWAP network implementation from [3].

We implement optimization n=82 QAOA with p=1. To perform optimization, we use a TPE optimizer with t=100 trials. Each trial corresponds to estimating the cost function value from s=1000 samples. The QAOA is implemented for a set of 10 Hamiltonians. For each Hamiltonian, the optimization is run independently for 20 random bitflip gauges.

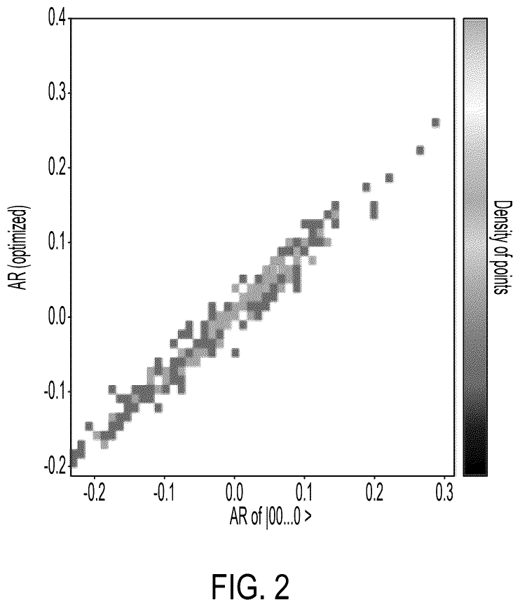

The 2-dimensional histogram obtained from experimental results is shown in FIG. 2. The results indicate a positive correlation between the approximation ratio of the |0 . . . 0)(0 . . . 0| state and the performance of optimization. Note that the results are much more spread out compared to numerical simulations for smaller systems (FIG. 1, right plot). Moreover, we do not observe flattening to the left of 0.0 approximation ratio. The results suggest that choosing the right gauge can improve the optimization in experiments. We further explore this idea by implementing Quantum Dissipative Recursion in the next section.

### 4.2 NDAR Benchmark

In the previous section, we demonstrated that choosing a gauge transformation that results in a Hamiltonian with a high approximation ratio of the state |0 . . . 0)(0 . . . 0| can result in improved optimization. Now we exploit this observation by experimentally implementing the Quantum Dissipative Recursion algorithm (see Algorithm 1) on n=82 qubits. We use standard p=1 QAOA ansatz with the linear SWAP network mentioned previously, for the same class of Hamiltonians as in previous subsections (SK model with ±1 interactions). We implement 10 random instances of the Hamiltonians. Each step of the QDR loop entails implementing TPE optimization using t=150 trials, with s=1000 samples each. Following Ref. [4] we additionally allow the optimizer to optimize over categorical variables controlling the gates' ordering of the ansatz (that ideally wouldn't change the circuit). We specify TERMINATION RULE for NDAR that terminates the loop if neither the minimal found energy nor the cost function (i.e., average energy) do not decrease compared to the previous step.

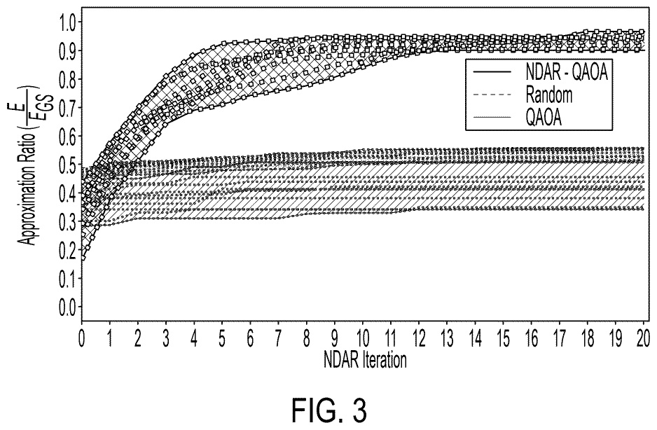

The results are presented in FIG. 3. The data points in the top figure correspond to the best value of the (rescaled by ground state energy) cost function, i.e., the best approximation ratio estimator (constructed from s=1000 samples) out of t=150 trials. The bottom figure shows the best-found solution, meaning the best bitstring out of 150*1000*(k+1) (k being iteration step counting from 0) samples. The NDAR results are colored red. We also implement the standard QAOA (blue points) with the same number of function calls and compare it with NDAR. For reference, we provide the best approximation ratios obtained from the same number of shots using uniformly random sampling (grey points).

We observe that NDAR improves the mean approximation ratios from range ≈[0.0, 0.18] (variation between Hamiltonians for standard QAOA, blue lines) to above 0.75 in all cases (QDR, red lines). In terms of solving the target problems, NDAR improves the best-found solutions from range ≈[0.34, 0.51] to ≈[0.9, 0.96]. In particular, without NDAR (blue lines), standard QAOA performs worse than random sampling (grey lines) when we consider the best sample (bottom FIG. 3), while NDAR allows to outperform both the standard QAOA and random sampling significantly already after 3 iterations. We note that presented results were obtained without using any error-mitigation techniques and the physical implementation of the variational circuits involved 2-qubit gate counts over 3000 for optimization of fully connected graphs on n=82 variables. Furthermore, the algorithm converged after at most 20 optimization runs (step 0 which is a standard QAOA, followed by 19 NDAR iterations involving gauge transformations), suggesting that overhead from using NDAR is not prohibitively high for n=82 qubits.

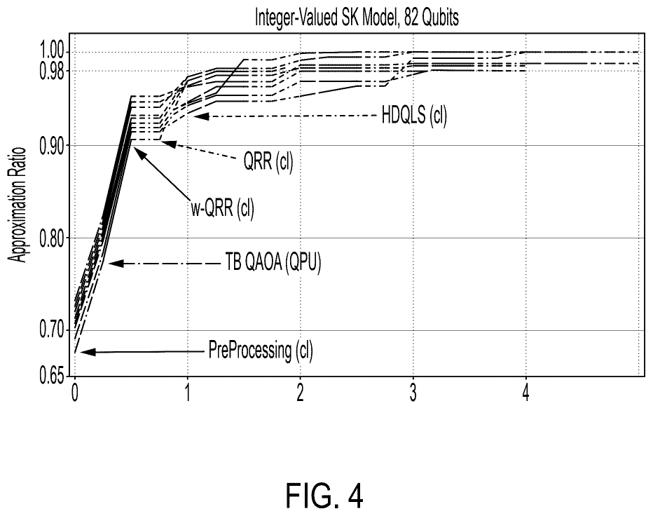

In FIG. 4 we can observe that improving the basic NDAR using the variants listed can be very beneficial. We observe that the pre-processing allows one to start already from approximation ratios around 0.7. Then, in the first iteration, the results obtained directly from QPU (via Time-Block QAOA) improve it to around 0.8. Weighted QRR provides further improvement of 0.1, performing better than standard QRR (which does not improve upon w-QRR). Finally, additional small improvements are gained by local search in the Hamming distance. Further iterations of NDAR refine the solution quality until we obtain ~0.98-1.0 AR for all tested instances with at most 4 NDAR iterations.

This application claims priority to U.S. Provisional Application Ser. No. 63/619,730 and U.S. Provisional Ser. No. 63/619,732, the entireties of which are incorporated herein by reference and selected portions of which are submitted herewith as Appendices 1-4.

### REFERENCES

[1]R. LaRose, E. Rieffel, and D. Venturelli, “Mixer-phaser ansätze for quantum optimization with hard constraints,” Quantum Machine Intelligence, vol. 4, no. 2, p. 17, 2022.
[2]R. Shaydulin, S. Hadfield, T. Hogg, and I. Safro, “Classical symmetries and the Quantum Approximate Optimization Algorithm,” Quantum Information Processing, vol. 20, oct 2021.
[3]Y. Hirata, M. Nakanishi, S. Yamashita, and Y. Nakashima, “An efficient method to convert arbitrary quantum circuits to ones on a linear nearest neighbor architecture,” in 2009 Third International Conference on Quantum, Nano and Micro Technologies, pp. 26-33, 2009.
[4]F. B. Maciejewski, S. Hadfield, B. Hall, M. Hodson, M. Dupont, B. Evert, J. Sud, M. S. Alam, Z. Wang, S. Jeffrey, B. Sundar, P. A. Lott, S. Grabbe, E. G. Rieffel, M. J. Reagor, and D. Venturelli, “Design and execution of quantum circuits using tens of superconducting qubits and thousands of gates for dense ising optimization problems,” 2023.
[5]D. Sherrington and S. Kirkpatrick, “Solvable model of a spin-glass,” Physical review letters, vol. 35, no. 26, p. 1792, 1975.
[6]J. Bergstra, D. Yamins, and D. Cox, “Making a science of model search: Hyperparameter optimization in hundreds of dimensions for vision architectures,” in Proceedings of the 30th International Conference on Machine Learning (S. Dasgupta and D. McAllester, eds.), vol. 28 of Proceedings of Machine Learning Research, (Atlanta, Georgia, USA), pp. 115-123, PMLR, 17-19 Jun. 2013.
[7]T. Akiba, S. Sano, T. Yanase, T. Ohta, and M. Koyama, “Optuna: A next-generation hyperparameter optimization framework,” in Proceedings of the 25th ACM SIGKDD International Conference on Knowledge Discovery and Data Mining, 2019.
[8]Q. A. team and collaborators, “qsim,” September 2020.
[9]S. V. Isakov, D. Kafri, O. Martin, C. V. Heidweiller, W. Mruczkiewicz, M. P. Harrigan, N. C. Rubin, R. Thomson, M. Broughton, K. Kissell, E. Peters, E. Gustafson, A. C. Y. Li, H. Lamm, G. Perdue, A. K. Ho, D. Strain, and S. Boixo, “Simulations of quantum circuits with approximate noise using qsim and cirq,” 2021.
[10] Maciejewski, Filip B., Jacob Biamonte, Stuart Hadfield, and Davide Venturelli. “Improving Quantum Approximate Optimization by Noise-Directed Adaptive Remapping.” arXiv preprint arXiv:2404.01412 (2024).
[11] Maciejewski, Filip B., Bao G. Bach, Maxime Dupont, P. Aaron Lott, Bhuvanesh Sundar, David E. Bernal Neira, Ilya Safro, and Davide Venturelli. “A Multilevel Approach For Solving Large-Scale QUBO Problems With Noisy Hybrid Quantum Approximate Optimization.” In 28th Annual IEEE High Performance Extreme Computing Virtual Conference. 2024.

1. A method for optimizing solutions to a query presented to a processing unit that is subject to a source of dissipative or other noise bias which drives the dynamics of the processing unit to output a specific state (the 0-state), the method comprising:
a) addressing to said processing unit an objective function (optimization problem) specified by coefficients and variables;
b) generating, by running instructions in said processing unit, one or more solution outputs using said objective function and objective function coefficients based on an input data set;
c) re-defining the 0-state as a new logical state of the processor via a mapping, and using said mapping to establish a set of multipliers or local quantum channels for use in transforming said objective function;
d) transforming said objective function by multiplying the objective function coefficients by said set of multipliers or by applying said quantum channels to objective function operators, to generate a set of transformed objective functions;
e) repeating steps a) and b) using said set of transformed objective functions to generate a subsequent iteration set of solution outputs;
f) processing said one or more solution outputs of step e) to identify at least one selected solution output for further processing;
g) repeating steps a) and b) with a transformed objective function corresponding to said at least one selected solution output for further processing;
h) thereby arriving at an optimized solution to said objective function.

2. The method of claim 1, wherein the processing unit is a gate-model quantum processor comprising gates and/or programmable interactions.

3. The method of claim 1, wherein the processing unit is a quantum processor comprising qubits and/or qudits.

4. The method of claim 1, wherein the processing unit comprises probabilistic bits (P-bits).

5. The method of claim 1, wherein the processing unit comprises variables encoded in coherent or incoherent light pulses or electromagnetic frequencies.

6. The method of claim 1, wherein the noise is engineered via an artificial bath (e.g. extra variables, stochastic perturbations).

7. The method of claim 1, wherein the noise is engineered algorithmically (e.g. Markov-Chain Montecarlo).

8. The method of claim 1, wherein the 0-state of the bias is not known, but the fact that it exists is known.

9. The method of claim 1, wherein the 0-state of the bias is not unique.

10. The method of claim 1, wherein the bias drives towards a steady state, a metastable state, or other attractor state of a physical dynamics.

11. The method of claim 1, wherein the outputs of step b) are strings of bits, integers and/or symbols.

12. The method of claim 1, wherein the input data are results of quantum measurements or standard readout in memory.

13. The method of claim 1, wherein the objective function is a quantum Hamiltonian or other non-classical operator and the output comprises results from quantum measurements following an information processing protocol (e.g. shadow tomography).

14. The method of claim 1, wherein multiple outputs are generated for each transformation.

15. The method of claim 1, wherein the mappings and transformations correspond to gauge symmetries of the objective function that leave the objective function invariant or approximately invariant.

16. The method of claim 1, wherein a subspace formed by high-quality solutions is preserved or re-mapped to a similar-size transformed subspace.

17. The method of claim 1, comprising selecting the transformation whose transformed-0-state corresponds to the highest-quality output of a set of outputs.

18. The method of claim 1, comprising selecting the transformation which is associated with a specific Hamming distance of the bitstring or other distance with respect to the 0-state.

19. The method of claim 1, comprising selecting the transformation which is associated with a specific distance with respect to a state other than the 0-state which is a reference state computed via a physical model or via empirical considerations, for example from an alternative classical algorithm.

20. The method of claim 1, comprising selecting a transformation via a neural-network or an algorithm taking as input the output of an iteration or of multiple iterations which has been designed or trained to discover the best transformation based on prior data and physics-informed design principles.

21. The method of claim 1, comprising selecting multiple transformations.

22. The method of claim 1, wherein post-processing includes one or more of error-mitigation, suppression and correction techniques to generate new derivative output that is used in the algorithm.

23. The method of claim 1, wherein the output could be measurement results (including weak quantum measurement) of a subset of the variables during method execution (e.g. mid-circuit measurement) at different times instead of measuring at the end to collect the output. Measurements results could also be used to modify the method.

24. The method of claim 1, wherein comprising changing the algorithm or its parameter setting strategy at each iteration.

25. The method of claim 1, comprising running multiple parallel (or sequentially scheduled) runs for which multiple choices of transformations are made at each iteration.

26. The method of claim 1, wherein multiple final solutions are chosen instead of one.

27. The method of claim 1, comprising using a metric other than quality to select a final solution.

28. The method of claim 1, wherein each iteration adds operations to the same quantum circuit or analog evolution without a full measurement (for which case the transformation would be implemented online via, for example, a measurement-feedback mechanism on a subset or the totality of qubits).
